(19) United States
(12) Patent Application Publication
(10) Pub. No.: US 2005/0091103 A1
(43) Pub. Date: Apr. 28, 2005

(54) Data base module and a method for the determination of personnel data

(75) Inventor: Hermann Neher, Aichwald (DE)

Correspondence Address: HOFFMANN & BARON, LLP, 6900 JERICHO TURNPIKE, SYOSSET, NY, 11791, US

(73) Assignee: FESTO AG & Co.

(21) Appl. No.: 10/924,137

(22) Filed: Aug. 23, 2004

(30) Foreign Application Priority Data
Aug. 28, 2003 (DE) 103 39 578.4

(51) Int. Cl. G06F 17/60

(52) U.S. Cl. 705/11

(57) ABSTRACT

A method and furthermore a data base module for the determination of personnel data. The data base module comprises: means for collecting actual competence values with respect to actual or prospective employees in a company for the establishment of actual competence profiles, means for collecting target competence values with respect to at least one person for the establishment of a target competence profile, and comparison means for taking at least one measure on the basis of a comparison of the actual competence values and the target competence values.

### BACKGROUND OF THE INVENTION

The invention relates to a data base module, a computer arrangement and furthermore a method for the retrieval of personnel data.

### THE PRIOR ART

Conventionally personnel data of persons employed in a company or with a prospect of being employed therein, are recorded in writing. For instance, personnel files are run for such persons. The term personnel data is generally taken to mean date of birth, employment in a company, professional or academic education or references of the persons. In principle there is also the possibility of storing personnel data in computers for example, and for instance in a data base. The personnel data are assigned to the respective person and conventionally are stored, for example under the person's name, personnel identification number or the like. With the aid of the name or the personnel identification number the data may be retrieved from the data base again. The personnel data may for example be utilized in writing a reference, in which the salary grade or the like are included.

As a controlling tool for a company or as an evaluating means for an evaluation of the company such personnel data are however for example not suitable. It is not possible, on the basis of the personnel data, to re-structure the company, or to ascertain new objectives and tasks for the company or to perform similar tasks. Put in simple terms, an efficient management of the company is not possible with the aid of conventionally archived personnel data.

### SHORT SUMMARY OF THE INVENTION

One object of the invention is accordingly to devise means and methods for efficient company management on the basis of personnel data.

In order to achieve these and/or other objects appearing from the present specification, claims and drawings, the present invention provides a data base module for determining personnel data with the following means:
means for collecting actual competence values with respect to actual or prospective employees for the establishment of actual competence profiles,
means for collecting and/or determining target competence values with respect to at least one person for the establishment of a target competence profile, and
comparison means for taking at least measure on the basis of a comparison of the actual competence values and the target competence values.

The target competence value or a plurality of target competence values for a plurality of persons are, as it were, filters, using which the target competence values are evaluated. The input of the target competence values may take place manually. However, it is preferred for the target competence values to be communicated to the data base module in an electronic form. For instance, the target competence values may be communicated by a balanced scorecard program. The data base module may be in the form of software and/or hardware. A version is particularly preferred in which the data base module cooperates with a business administration program as for example SAP R2 or R3 and/or in a modular fashion is integrated in such software.

A further form of the invention contemplates a data base module for the collection and/or determination of personnel data comprising:
collecting means for the collection of actual competence values with respect to an employee of a company for the establishment of actual competence profiles,
means for the determination of at least one financial evaluating coefficient for at least one person characterized by the multiplication of at least one actual competence value by an evaluation factor, and
output means for the output of the at least one evaluating coefficient.

The output means communicate the evaluating number for example to an operator interface. It is however more especially preferred for the output means to communicate the evaluating coefficient, preferably a group of evaluating coefficients, to a financial management software module, for example of the same type as the above mentioned business administration program.

The personnel data accordingly are useful in more than one way: on the basis of the data base module in accordance with the invention the personal potential of the company may be evaluated on the basis of financial values or data, something that is significant for when applying for loans for the company. The human capital of the company may thus be simply reflected in the balance statement, which is at least partially generated by a business administration program module and/or the data base module of the invention.

Furthermore the invention provides methods, which function like the above mentioned data base modules.

Advantageous developments of the invention are recited in the claims and are described in the specification.

Preferably in the case of the above mentioned data base modules means are provided for the selection of the actual competence values and/or the target competence values from a selection list with predetermined competence value stages. The competence values are as it were indexed. In the selection list the competence stages of beginner, trainee, experienced employee, highly qualified employee and specialist are provided for example. A beginner has no professional pretraining. A trainee on the other hand will already have a certain degree of experience. As compared with a trainee an experienced employee will have acquired further experience and a highly qualified employee will have a complete knowledge relevant for his activities. A specialist will have knowledge going far beyond the scope required. The specification of the actual competence values or, respectively, of the target competence values is facilitated by the above mentioned measure. The operator merely has to make a selection from the selection list offered to him with the competence value stages. It will be clear that however also floating values, fine graduations or the like may be provided.

Preferably means are present in the data base modules for grouping the actual competence values and/or the target competence values in competence categories. Such competence categories are for example professional competence, method competence, social competence, personal competence and furthermore business competence of a person. The competence categories can be also termed competence fields. Professional competence comprises for example education, analytical thinking and performance and the quality orientation of an individual. Method competence relates for example to specialized knowledge, ability in foreign languages, ability to solve problems, process confidence and the like. Social competence of a person would be taken to mean ability to work in a team, to cooperate, to be integrated, to convince others or the like. Personal competence may for example be ability to pursue an aim, to make judgments, confidence, humor and adaptability of a person. Business competence relates for example to the ability to delegate activities, cost-mindedness, ability to think in terms of profitability, strategic thinking and performance. It will be clear that other arrangements in categories are conceivable.

Preferably, the data base modules possess means for the provision of the actual competence values and/or the target competence values with one or more weighting factors. The weighting factors are preferably dependent on the competence categories. For instance, the professional competence may be give a higher value than the business competence or the like. The weighting factors are preferably able to be set dynamically by the operator of the data base module. Using the weighting factors the operator may decide which competence values are particularly significant for the current data evaluation.

Preferably, during the comparison of the actual competence values and the target competence values, the comparison means find difference values. In the case of a negative difference value the respective person will be lacking, for example, in one competence aspect, while in the case of a positive difference the competence will be better expressed than is demanded by the target competence value.

In the case of first mentioned data base module in accordance with the invention the at least one measure, which is taken on the basis of the comparison of the competence values, comprises various versions, which may be combined with one another as well.

Preferably the measure comprises finding a targeted person. For instance a targeted person may be found by a target-actual comparison of the competence values.

The following measure provides for a further qualification of the persons found by the data base module. For instance, on the basis of a target-actual comparison it is possible to find which qualifying measure is necessary for one or more persons. The qualifying measure serves for reducing a deviation between the actual and the target competence values. The qualifying measures are for example indexed in the type of the actual competence values or, respectively, the target competence values and held in a memory of the data base module. The data base module checks for example to see whether a predetermined difference value between a target competence value and an actual competence value may be reduced by the corresponding competence improvement value, which is assigned to the qualifying measure.

Further selection criteria for the qualifying measure may for example be the price thereof, duration or the like. The data base module selects the most suitable qualifying measures. It is possible as well for the data base module to offer a plurality of qualifying measure, same being best sorted in a predetermined order in accordance with at least one sorting criterion. An operator can activate the corresponding qualifying measure, for example at an operator interface of the data base-module.

It will be clear that the data base modules of the invention are in principle suitable for the processing of the competence values of a single person. However for the processing of the competence value the data of several person have turned out to be particularly suitable. A particularly preferred form of the invention contemplates a system in which the data base module in accordance with the invention comprises means for finding the target competence values of a plurality of person of a first person group for the performance of a first task and means for finding persons, available in the company, on the basis of the actual competence values. For the task competence values of several persons are defined. On the basis of such target competence values the data base module locates several persons on the basis of the actual competence values. This measure may be provided for example for the manufacture of a given article or the like.

It is also possible for several tasks to be processed in such a manner. For instance, a first task may already be in progress in the company. For the first task a predetermined group of persons is required. If now a second task is planned, the persons required therefor are found in the above mentioned fashion using the data base module. The data base module of the invention then best finds persons, which are necessary both for the first and also for the second task, but however are only available once over for the company. I. e. the persons are accordingly required for both tasks.

In the case of such an initial situation occurring the data base module preferably serves as a simulation tool and/or as an optimizing tool. The data base module then develops scenarios, in which one or more persons required for both tasks are to be assigned at one time to one task and another time to the other task and consequently are absent from the other respective task. The data base module can even here constitute an optimizing tool, which so assigns the persons required for both tasks to the tasks that both tasks are implemented with maximum efficiency. Accordingly the measures taken are possible with respect to more than two tasks.

The following measure serves for data administration as regards the actual competence values. However, in principle it may be utilized for the target competence values too. Preferably a data base module in accordance with the invention comprises output means for the output of an input request for the input of modified target competence values in a manner dependent on at least one condition. For instance, the input request may be issued at set intervals in time. Furthermore the input request is for example generated after the performance of such an above mentioned qualifying measure. Moreover, if one person is assigned to another function, as for example when he is put on a different job in the company, the actual competence values are to be modified, for which the database module in accordance with the invention will preferably issue a request.

Preferably the data base module in accordance with the invention comprises check means for the checking access in the case of the input of the actual competence values and/or of the target competence values. This means that only authorized persons can modify the competence values.

A further particularly preferred form of the invention contemplates having release means for the release and following acceptance of entered actual competence values and/or target competence values. The corresponding competence values are for example entered by the person, to whom the competence values are assigned, himself. For instance employees of the company will themselves enter their respective competence values. The competence values are intermediately stored. After checking the competence values by an authorized person, as for example an executive in charge of the employees, the competence values are accepted by the data base module.

Further advantageous developments and convenient forms of the invention will be understood from the following detailed descriptive disclosure of embodiments thereof in conjunction with the accompanying drawings.

### LIST OF THE SEVERAL VIEWS OF THE FIGURES

FIG. 1 shows a computer arrangement having a data base module in accordance with the invention.

FIG. 2 diagrammatically shows a function chart of the data base module in accordance with FIG. 1.

FIG. 3 shows the input menu of the data base module in accordance with FIGS. 1 and 2.

FIG. 4 diagrammatically shows a simulation performed for example by the data base module in accordance with FIGS. 1 and 2.

### DETAILED ACCOUNT OF WORKING EMBODIMENTS OF THE INVENTION

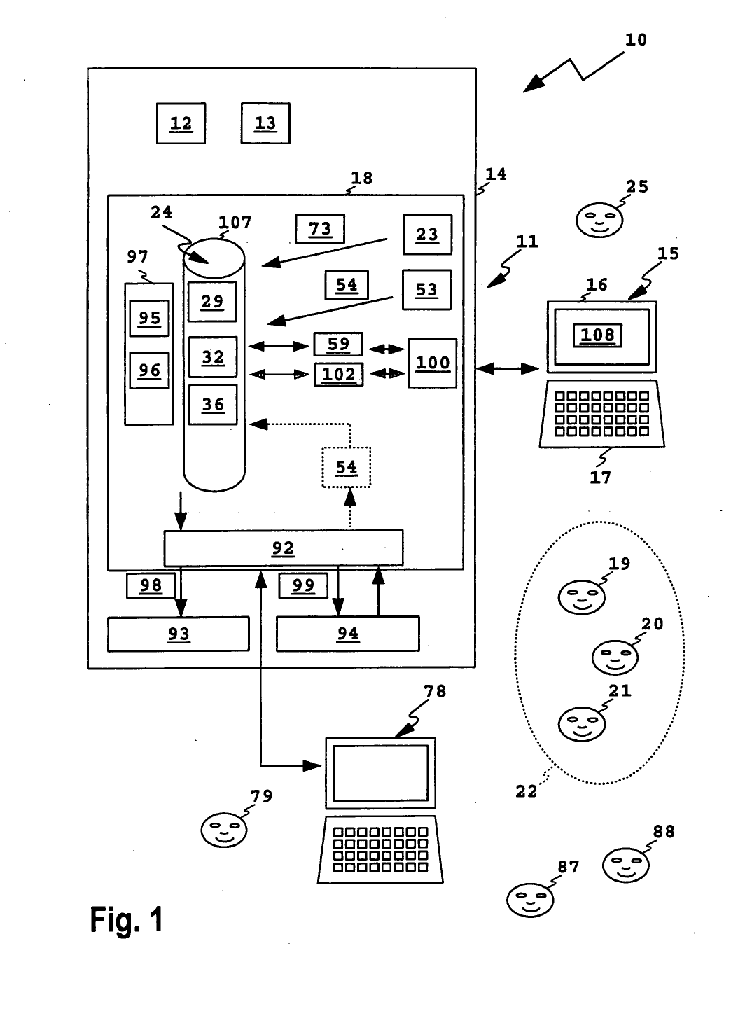

FIG. 1 shows a computer arrangement generally referenced 10. The computer arrangement 10 may comprise one or more computers preferably in a network with each other. For reasons of simplification the arrangement in the working example only comprises the computers 11 and 78, as for example PCs. The computer 11 comprises one or more processors 12, memory means 13, f. i. RAMs or ROMs (random access and read only memories), hard disk drives or the like, which are arranged in a housing 14, and furthermore input-output means 15, as for example a display 16 and a keyboard 17. The processor 12 may execute program code of program modules, for example of a data base module 18, which are stored in the memory means 13.

The data base module 18 serves in accordance with the invention for providing personnel data. Using the data base module 18 methods in accordance with the invention may be performed.

The data base module 18 serves for determining personnel data of person 19, 20, 21 and also 87 and 88, who are employed in a company 22 or are to be employed. The company 22 produces pneumatic components for example. The persons 19 through 21 and further persons not represented are for example engaged with production and marketing of the compressed air components, with management tasks, with personnel management functions or the like.

The persons 19 through 21 employed in the company 22 have different levels of competence, as for example a different training and courses of study, different foreign language skills, different communicative skills and different approaches to customers or the like. It is admittedly possible in principle to archive such data in writing, for example in the form of record cards or the like. The administration of such accumulations of data, keeping them up to date, access to the data or the like is however extremely difficult so that such data may only be utilized by the company 22 to a limited extent. It is here that the invention comes into play.

The data base module 18 renders possible a qualified and categorized collection and/or determination of personnel data 24 for the persons 19 through 21 and offers a wide variety of possibilities of application for the personnel data 24, something which in the following will be made clear by description of the function of the data base module 18.

With the aid of collection means 23 the personnel data 24 for the persons 19, 20 and 21 may be collected. The personnel data 24 are entered by an operator 25 of the computer 11, for example at a keyboard 17. In this respect the collection means 23 indicate collection or entry masks, for example in the form of a menu 26, on the display 16. The menu 26 is for example generated by output means 100, in the case of which it is for example a question of a program for the generation of a graphic operator interface.

The operator 25 enters the personnel data 24, in a form structured by the collection means 23, for the persons 19 through 21. For instance for the person 19 the data base module 18 collects actual competence values 37 and 28 of an actual competence profile 29, for the person 20 actual competence values 31 and 31 of an actual competence profile 32 and furthermore for the person 21 actual competence values 33 of an actual competence profile 35. The actual competence profiles 29, 32 and 35 comprise further actual competence values which are not illustrated for reasons of simplification. The data base module 18 stores the personnel data 24 in a memory zone 107.

The actual competence values of the profiles 29, 32 and 35 are put in competence categories or competence groups. Categorization in accordance with the initially mentioned five categories has proved to be particularly satisfactory, namely professional, methodic, social, personal, and management competence of the persons 19 through 21. The actual competence values 27, 30 and 33 relate for instance to the training of the respective persons 19, 20 and 21 and accordingly a professional competence, which is termed the competence category 36. The actual competence values 28, 31 and 34 relate to the ability to concentrate of the persons 19, 20 and 21 and therefore to a form of personal competence. Personal forms of competence are put in the competence category 37.

Moreover the actual competence profiles 29, 32 and 35 also for example comprise actual competence values as regards managerial competence of the persons 19 through 21. The forms of managerial competence are put in a competence category 38. For instance an actual competence value 39, which describes the identification of the person 19 with the company 22 or strategic thinking and performance of the person 19, is put in the competence category 38.

The menu 26, which for example is displayed at a graphic operator interface of the input-output means 15, renders possible the entry or input of the actual competence values 27, 28, 30, 31, 33, 34 and 39 and furthermore other competence values, which are not indicated. The menu 26 offers an operator 25 selection lists with predetermined competence value stages for the entry of the competence values. For instance for the actual competence value 27 the stages 40 through 43 can be selected from a selection list 101, the stage 40 for instance relating to a beginner, the stage 41 to an experienced person with a professional education for specific trade, the sate 42 to a person fresh from a university, the stage 43 to specialist with a university education and several years of specialized-occupatonal experience. It will be clear that further more detailed graduations are readily possible. The collection means 23 responds to which of the stages 40 through 43 are marked by the operator 21 f. i. with the computer mouse, and applies the corresponding competence stage to the actual competence value 27 on acceptance in the personnel data 24.

The actual competence value 28 can have extremely fine graduations. The menu 26 shows for this purpose a sort of graphic slide regulator 44, which may be shifted between one position 45 and a position 46. In the position 45 the collection means 25 assign for example a small numerical value to the actual competence value 28, while in the position 46 the numerical value is large. In the case of intermediate positions of the slide regulator 44 the collection means 23 assign corresponding intermediate values to the actual competence value 28, fine gradations, and possibly continuous intermediate values being possible if appropriate. The slide regulator 44 is for example able to be operated using the keyboard 27, a computer mouse or the like.

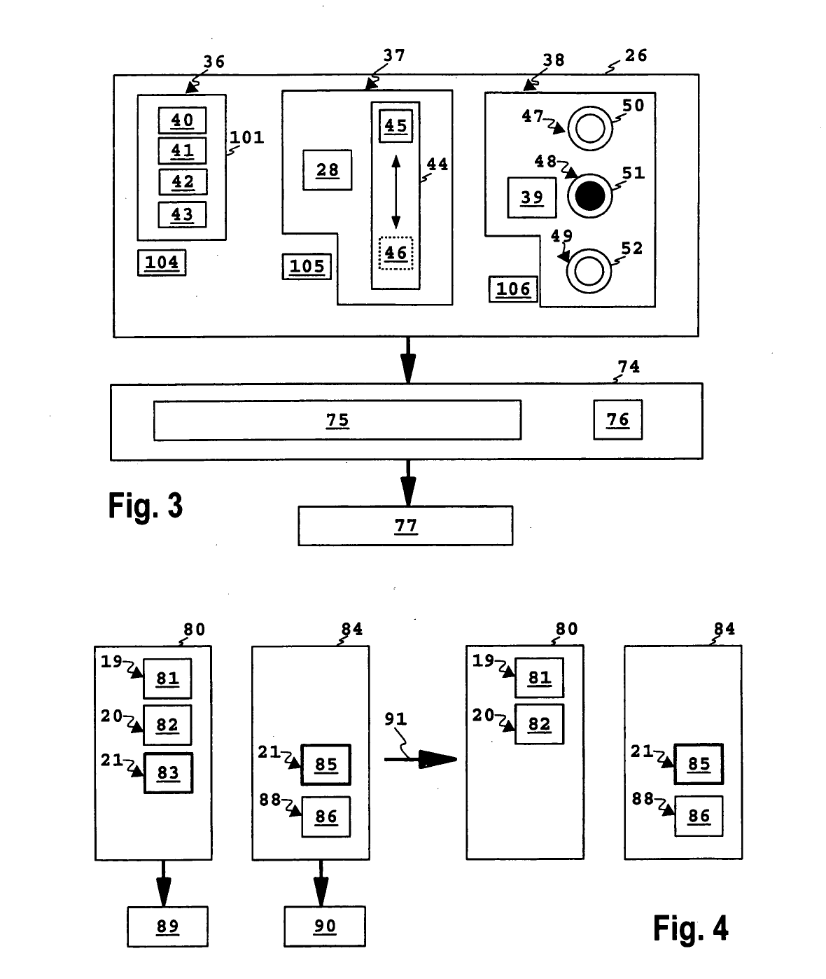

For the actual competence value 39 competence stages 47 through 49 may be selected, for instance using the mouse of the computer 11 to select selection fields 50 through 52, which are assigned to the stages 47 through 49. It is merely one of the selection fields 50 through 52 which is selectable. FIG. 3 for instance shows the selection field 51 assigned to the stage 48 as being marked. Dependent on the respectively selected selection field 50, 51 and 52 the collection means 23 assign a corresponding numerical value (which is noted in the respective personnel data 24) to the actual competence value 39. The stages 47, 48 and 49 correspond f. i. to the numerical values 25, 27 and 125. The numerical value 25 means f. i. “not present”, the numerical value 25 “substantially complied with” and the 125 “overly complied with”. It will be clear that intermediate stages, as for example with numerical values 50 and 100 (corresponding to “lacks experience”, “not yet met” and “completely complied with”) are possible.

The actual competence values 27, 28, 30, 31, 33 and 34 and further actual competence values can also be entered via the menu 26.

The actual competence values 27, 28, 30, 31, 33 and 34 are for example noted as a sort of numerical code or index, which may be also termed a qualification index, in the personnel data 24. In this respect a preceding first number (prefix) of the respective numerical code with numerical values of 1 through 5 stand for the competence category 36 to 38 and two further competence categories, not illustrated. This may be followed for example by two or three further numbers, which denote a subcategory of the above mentioned competence categories, as for example a subcategory of the competence category 36. Within the competence category part it is possible to have numerical values with reference to the actual competence values, as for example the stages 40 through 43 for the actual competence values 27, 30 and 33. The numerical values for the competence category and the competence category part are as it were identifiers for the location of a competence value, which preferably may assume predetermined competence stages. It is clear that other methods as well are possible for identifying and qualifying a competence value within the personnel data 24, which preferably are organized in the form of a data base.

Using the data base module 18 the personnel data 24 may be evaluated in various different expedient ways. For instance within the company 22 a person is sought for a predetermined activity. For instance it is a question of developing a certain product, of finding someone for an executive position, an assembly fitter or the like.

For this purpose collecting means 53 collect one or more target competence profiles 54. On the basis of the target competence profile 54 for example one person is to be found for an executive position. For this purpose the collecting means 53 interrogate target competence values 55 and 56, for example using the input-output means 15. For this purpose for example an interrogation menu 108 is provided as a form of the menu 26. The target competence values 55 and 56 correspond to the actual competence values 27, 28 and, respectively, 30, 31 and 33, 34. The target competence profile 54 may, like the actual competence profiles 29, 32 and 35, comprise further target competence values.

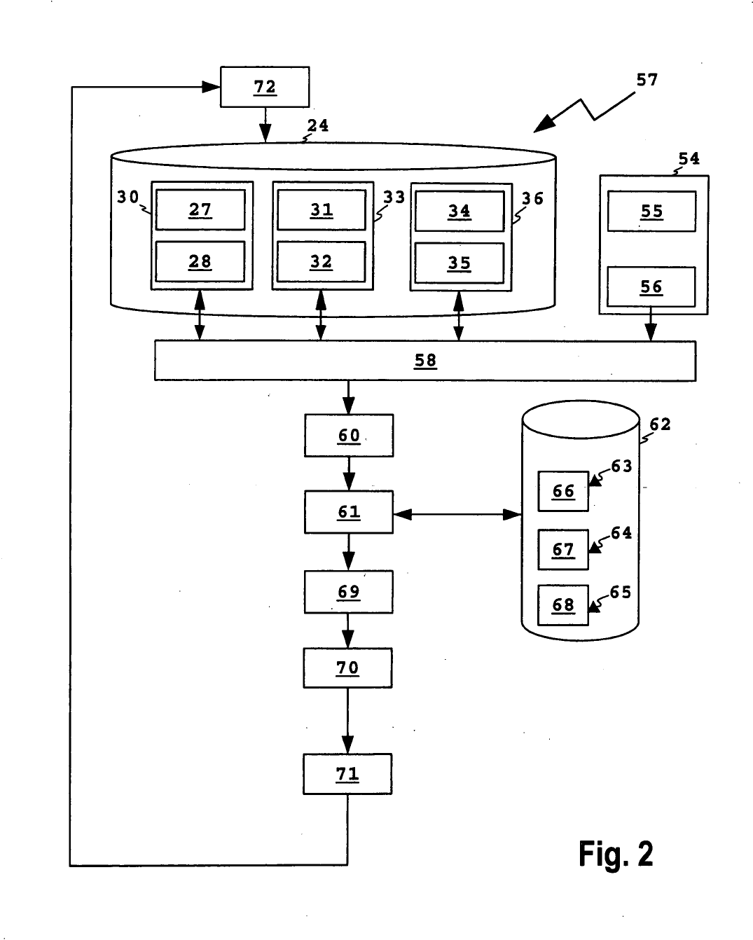

An application in accordance with the invention of the target competence profile 54 is indicated diagrammatically in FIG. 2 by a chart 57.

In a step 58 the data base module 18 collects the target competence profile 54. The target competence profile 54 is a sort of search mask, with which the data base module 18 interrogates the personnel data 24. The comparison means 59 for example determine difference values between the actual competence values of the actual competence profiles 29, 32 and 35 and the target competence values of the target competence profile 54. In the case of such a formation of difference values the comparison means 59 may for example find that the difference values between the actual competence values 31, and 32 and the target competence values 55 and 56 are the smallest ones.

In one step 60 on the display 16 the data base module 18 indicates that the person having the actual competence profile is the most suitable targeted person for the position to be occupied in the company 22.

It is possible as well for the operator 25 to set weighting factors 104, 105 and 106 for the selection of a suitable person. For instance he can give greater weight to social competence than to professional skill for the selection of someone for a managerial position. In a corresponding manner the comparison means 59 will retrieve a suitable actual competence profile from the personnel data 24. In this case for example a difference between the target competence value 55 and the actual competence values 27, 31 and 34 will be given less weight than a difference between the target competence value 56 and the actual competence values 28, 32 or 35.

It may be that the person 20 compiles with all conditions, which are demanded by the target competence profile 52. In practice deviations from this frequently occur, i.e. a person may comply with many but not all of the requirements of a target competence profile. A lack of competence may be reduced in a simple fashion by using the data base module 18.

In one step 61 the data base module 18 determines a suitable qualifying measure on the basis of qualifying data 62. For instance a difference between the actual competence value 31 and the target competence value 56 is to be reduced. The qualifying data 62 comprise, as regards the qualifying measures 62 through 65, competence improvement values or qualifying values 66, 67 and 68, the competence improvement values 56 and 57 for example setting the scope within which a difference between the actual competence value 31 and the target competence value 56 can be reduced. The competence improvement value 68 defines for example to what degree a deviation may be reduced between the target competence value 55 and one of the actual competence values 27, 30 and 33.

The person 20 has a deviation between the target competence value 56 and the actual competence value 31. Accordingly the data base module 18 indicates qualifying measures 63 and 64 on the display 16 in a step 69. The operator 25 can activate the corresponding qualifying measure 63 or 64 for the person 20, the qualifying measure being for example ordered electronically and the person 20 being informed as regards the planned qualifying measure. In the step 69 it would be feasible for other values associated with the qualifying measures 63 and 64 to be displayed, for instance the costs of the respective qualifying measure 63 and 64. It is possible for the most economic qualifying measure 63 or 64 to be selected and displayed even in the step 69.

In a step 70 a timer is started, which for example corresponds to the duration of the selected qualifying measure 63 and 64. After the selected qualifying measure 63 or 64 has been performed, the timer runs for the step 70 and the data base module 18 produces in a step 71 a request on the display 16 for administration work on the personnel data 24.

In a step 72 for example the menu 26 is displayed for the person 20 so that the actual competence value 31, improved using the selected qualifying measure 63 and 64, may be entered in the personnel data 24.

Basically the actual competence values of the personnel data 24 may be cited by every person entitled to assess the persons 19 through 21 employed in the company 22. Preferably an employee of the Human Resources Management Unit, an executive or the like will enter updated actual competence values. Check means 73 are provided to prevent fraudulent entry of actual competence value for checking entry of actual competence values and target competence values in the personnel data 24. After for example updated actual competence values have been entered by way of the menu 26, the check means 73 activate an entry mask 74 at the input-output means 15. For acceptance of modified actual competence values from the menu 26 in the personnel data 24 an entry field 75 of the input mask 74 an access code must be entered, for example by way of the keyboard 17 and the graphically represented confirmation key is to be operated. Then the data base module 18 accepts the modified actual competence values in the personnel data 24 in a step 77.

It is also possible for the person, who is characterized by the respective actual competence values, to himself modify his actual competence values. For instance the person 20 could, after complying with the qualifying measure 63 or 64, modify the actual competence value 31 by way of the input menu 26. However, the person 20 might enter an inappropriate actual competence value 31. To prevent such a improper use the data base module 18 will display, for example, the modified actual competence value 31 and furthermore the entry mask 74 at a computer 78 linked with the computer 11, for example by a network. A person 79 checking the system enters a release code by way of the entry field 75. Then the data base module 18 will accept the modified actual competence value 31 in the step 77 in the personnel data 24. The check means 73 are in the present case authorizing or release means as well.

In an efficient manner the data base module 18 renders possible planning of resources for an existing task or a future task of the company 22. For instance the persons 19, 20 and 21 are employed on a first task 80. The task 80 is characterized by the target competence profiles 81, 82 and 83, that are assigned to the persons 19, 20 and 21 and for instance can be entered by the collecting means 53. With the aid of the target competence profiles 81 through 83, the data base module 18 finds, for example using the comparison means 59, the persons 19, 20 and 21 in the personnel data 24 by a comparison with actual competence values, for example as described above. The task 80 relates for example to the manufacture of a first model of pneumatic cylinders.

Now a second model of the pneumatic cylinders is to be developed and manufactured and for this a second task 84 is planned. The persons required for the second task 84 are defined in the case of the data base module 18 by target competence profiles 85 and 86, f. i. by the entry of target competence values by way of an entry menu like the menu 26. On the basis of the target competence profile 85 the data base module 18, for example with the comparison means 59, determines that the person 21 is suitable for the task 84. The person 21 is however already working on the first task 80. The persons 19 and 20 put on the first task 80 are on the contrary not required for the second task 84.

The person defined by the target competence profile 86 is not available in the company 22. For instance the data base module 18 generates an automated job description for acquiring the person defined by the target competence profile 86. This job specification of the company 22, which is transmitted via email to the labor exchange and labor agencies or the like and which is indicated on the homepage of the company 22 by way of the Internet, is responded to by persons 87 and 88. The data base module 18 collects, i.e. has entered into it, the actual competence values of the persons 87 and 88 in the above mentioned manner and enters the actual competence values as part of the personnel data 24. On the basis of the target competence profile 86 the comparison 59 means find that the actual competence profile of the person 88 best suit the target competence profile 86. The person 88 is hired by the company 22. In principle therefore the persons required for the task 84 would be found. However there is also the possible conflicting situation that the person 21 would be required both for the first and also for the second task 80 and 84.

On the basis of the actual competence values applying for the persons 19, 20, 21 and, respectively, 88 simulating means 102 of the data base module 18 simulate the effect of an assignment of the person 21 to the first task 80 or to the second task. Such simulation means 102 indicate data 89 and 90 on the display 16 as regards the effects produced. The effect data 89 and 90 will for example comprise respective data as to the numbers of the first or the second pneumatic cylinder produced, and what profits or the like would be obtained with or without the employment of the person 21.

Using the input-output means 15 the operator 25 is able to stipulate an optimizing criterion, as f. i. “maximum profit”, on the basis of which the data base module 18 can make an optimum assignment of the person 21 to the first or second task 80 and 84. In the present case the data base module 18 selects a version, in the case of which the person 21 is assigned to the second task 84. In FIG. 4 the assignment of the person 21 to the task 84 is indicated by an arrow diagrammatically.

It is also possible for the data base module 18 to show a selection menu on the display 16 and for example for the operator 25 to assign the person 81, suitable for both the first and for the second task 80 and 84, to the first or the second task 80 and 84.

In the above possibilities the actual competence values and the target competence values were indicated at the input-output means 15. By way of an interface 92 the data base module 18 is able to be coupled with a business administration program module 93 and also with a company management program 94. The data base module 18 determines, on the basis of the actual competence values of the actual competence profiles 29, 32 and 35, for instance a monetary value, which the persons 19, 20 and 21 have for the company 22. For instance evaluating means 103 of the data base module 18 multiply the actual competence values 27, 30 and 33 with an evaluating factor 95 and multiply the actual competence values 28, 31 and 34 with an evaluating factor 96 of an evaluating profile 97 in order to find an evaluating coefficient or, respectively, an evaluating coefficient field 98. Then the data base module 18 communicates the evaluating coefficients 98 to the business administration program module 93 via the interface 92. The business management program module 93 incorporates the weighting coefficients 98 in the balance of the company 22, for example.

The company management program module 94 is for example on the basis of so-called Balanced Scorecards (BSC). BSC's are controlling instruments or, respectively, company management instruments which have been developed by Robert S. Kaplan and David B. Norton. For instance the evaluating means 103 of the data base module 18 supply characteristics 99, which have been found on the basis of the actual competence profiles 29, 32, and 35 to the program module 94. In the reverse direction the program module 94 can also find target competence profiles, for example the target competence profile 54 or the target competence profiles 85 and 86 using BSC characteristics and feed them to the data base module 18. It is also possible for the program module to supply-BSC characteristics, from which the data base module 18 forms target competence profiles.

The collecting means 23 and 53, the comparison means 19, the simulating means 102 and the check means 73 are for example program or software functions.

1. A data base module for the collection of personnel data comprising
a data base module for determining personnel data with the following means:
means for collecting actual competence values with respect to actual or prospective employees in a company for the establishment of actual competence profiles,
means for collecting and/or determining target competence values with respect to at least one person for the establishment of a target competence profile, and
comparison-means for taking at least one measure on the basis of a comparison of the actual competence values and the target competence values.

2. The data base module as set forth in claim 1 comprising means for the selection of the actual competence values and/or the target competence values from a selection list with predetermined competence value stages.

3. The data base module as set forth in claim 1 comprising means for grouping the actual competence values and/or the target competence values in competence categories.

4. The data base module as set forth in claim 1 comprising means for the provision of the actual competence values and/or the target competence values with weighting factors, more particularly in a manner dependent on the competence categories.

5. The data base module as set forth in claim 1 wherein as part of the comparison of the actual competence values with the target competence values by said comparison means, such means determine difference values on the basis of the actual competence values and the target competence values.

6. The data base module as set forth in claim 1 wherein the at least one measure comprises the determination of a targeted person.

7. The data base module as set forth in claim 1 wherein the at least one measure comprises the determination of a qualifying measure for a person, the qualifying measure being provided for reducing a deviation between the actual competence values and the target competence values for the person.

8. The data base module as set forth in claim 1 comprising means collecting target competence values with respect to several persons in a first person group for the performance of a first task and means for determining persons available for the first task in the company on the basis of the actual competence values.

9. The data base module as set forth in claim 8 wherein the means are designed for the determination of target competence values of several persons of a second person group for working on a second task and for determining persons available in the company for working on the second task and are designed for the determination of at least one person available both for the first and also the second task, such person however only being available in the company once over.

10. The data base module as set forth in claim 9 wherein the means for the determination of the effect on the first task on selection of the at least one person necessary for the first and are designed for the second task and/or vice versa.

11. The data base module as set forth in claim 9 wherein the means for the selection of the at least one person necessary for the first and for the second task are designed on the basis of at least one selection criterion for that first or that second task, in the case of which the transfer of the person from the task would have the greater effect.

12. The data base module as-set-forth in claim 1 comprising output means for the output of an entry request for the input of modified actual competence values in a fashion dependent on at least one condition.

13. The data base module as set forth in claim 1 comprising check means for access checking on the entry of the actual competence values and/or the target competence values.

14. The data base module as set forth in claim 1 comprising release means for the release and subsequent acceptance of entered actual competence values and/or target competence values.

15. The data base module as set forth in claim 1 comprising program code able to be executed by a processor of a computer and more particularly of a personal computer.

16. A computer arrangement and/or storage medium with a data base module as set forth in claim 15.

17. A data base module for the collection of personnel data comprising:
collection means for the collection of actual competence values with respect to employees of a company for the establishment of actual competence profiles,
means for the determination of at least one financial evaluating coefficient for at least one person characterized by the actual competence values, by the multiplication of at least one actual competence value by an evaluation factor, and
output means for the output of the at least one evaluating number, more particularly to a business administration program module.

18. The data base module as set forth in claim 17 comprising program code able to be executed by a processor of a computer and more particularly of a personal computer.

19. A computer arrangement and/or storage medium with a data base module as set forth in claim 18.

20. A method of determining personnel data comprising the steps of:
collection of actual competence values with respect to the actual or prospective employees of a company for the establishment of actual competence profiles,
determination of target competence values for at least one person for the establishment of a target competence profile,
comparison of the actual competence values with the target competence values in order to cause at least one measure to be taken.

21. A method for the determination of personnel data comprising the steps of:
collection of actual competence values with respect to persons employed in a company for the establishment of actual competence profiles,
collection of at least one financial evaluation coefficient for at least one person characterized by the actual competence values by multiplication of at least one actual competence value with an evaluation factor, and
output of the at least one evaluation coefficient, more particularly to a business administration program module.
